(19) United States
(12) Patent Application Publication
(10) Pub. No.: US 2025/0373971 A1
(43) Pub. Date: Dec. 4, 2025

(54) EARPHONE DEVICE AND IDENTIFYING METHOD OF WEARING

(71) Applicant: COMPAL ELECTRONICS, INC., Taipei City (TW)

(72) Inventors: Ting-Chieh Huang, Taipei City (TW); Hsin-Yu Lai, Taipei City (TW); Kun-Yen Liu, Taipei City (TW); Ting-Wei Wu, Taipei City (TW); Shi-Kuan Chen, Taipei City (TW)

(73) Assignee: COMPAL ELECTRONICS, INC., Taipei City (TW)

(21) Appl. No.: 18/963,518

(22) Filed: Nov. 28, 2024

Related U.S. Application Data
(60) Provisional application No. 63/652,658, filed on May 28, 2024.

(51) Int. Cl. H04R 1/10; H04R 1/08; H04R 5/04

(52) U.S. Cl. CPC H04R 1/1041; H04R 1/08; H04R 5/04; H04R 2420/05; H04R 2460/07

(57) ABSTRACT

An earphone device and an identifying method of wearing are provided. The upper limit distance and the lower limit distance of the reference range are configured, where the upper limit distance and the lower limit distance are based on the distances between the reference position of the earphone device and the contour of the cavum concha or the cymba concha, respectively. Whether the distance information obtained by the distance sensor is within the reference range is determined, to generate left and right decision information, where the left and right decision information is whether the right ear is worn or the left ear is worn.

### CROSS-REFERENCE TO RELATED APPLICATION

This application claims the priority benefit of U.S. provisional application Ser. No. 63/652,658, filed on May 28, 2024. The entirety of the above-mentioned patent application is hereby incorporated by reference herein and made a part of this specification.

### BACKGROUND

### Technical Field

The disclosure relates to an earphone technology, and in particular relates to an earphone device and an identifying method of wearing.

### Description of Related Art

The majority of wireless earphone products available in the market are typically offered in paired form (e.g., a left ear device and a right ear device), in which the audio content emitted from the left and right earpieces differs. However, the left ear device and the right ear device are not very identifiable, causing users to easily make mistakes in wearing the device, thereby causing inconvenience in using the product.

### SUMMARY

An earphone device and an identifying method of wearing, which may improve the convenience of wearing, are provided in the disclosure.

The earphone device of the embodiment of the disclosure includes (but is not limited to) a distance sensor, a storage, and a processor. The distance sensor is configured to obtain distance information. The storage is configured to store program code. The processor is coupled to the distance sensor and the storage. The processor is configured to load the program code and execute: configure an upper limit distance and a lower limit distance of a reference range, in which the upper limit distance and the lower limit distance are based on distances between a reference position of the earphone device and a contour of a cavum concha or a cymba concha respectively; and determine whether the distance information is within the reference range to generate left and right decision information, in which the left and right decision information is whether a right ear is worn or a left ear is worn.

The identifying method of wearing according to the embodiment of the disclosure is suitable for an earphone device. The earphone device includes a distance sensor. The identifying method includes (but is not limited to) the following operation: configuring an upper limit distance and a lower limit distance of a reference range, in which the upper limit distance and the lower limit distance are based on distances between a reference position of the earphone device and a contour of a cavum concha or a cymba concha respectively; and determining whether the distance information obtained by the distance sensor is within the reference range to generate left and right decision information, in which the left and right decision information is whether a right ear is worn or a left ear is worn.

Based on the above, in the earphone device and the identifying method of wearing of the embodiment of the disclosure, the reference distance are defined according to distances between a reference position of the earphone device and a contour of a cavum concha or a cymba concha respectively, and the decision information related to left and right ear wearing is determined according to the comparison between the distance information and the reference range. In this way, the earphone device may be universally worn in both left ear and right ear, allowing the user to directly wear the earphone device without having to identify the wearing orientation, thus improving convenience.

In order to make the above-mentioned features and advantages of the disclosure comprehensible, embodiments accompanied with drawings are described in detail below.

### BRIEF DESCRIPTION OF THE DRAWINGS

FIG. 1 is an element block diagram of an earphone device according to an embodiment of the disclosure.

FIG. 2A is a schematic diagram of an earphone device according to the first embodiment of the disclosure.

FIG. 2B is a side diagram of the earphone device according to the first embodiment of the disclosure.

FIG. 3A is a schematic diagram of scanning ranges according to an embodiment of the disclosure.

FIG. 3B is a schematic diagram of distance and angle definitions according to an embodiment of the disclosure.

FIG. 3C is a schematic diagram illustrating an earphone device worn on the left ear according to the first embodiment of the disclosure.

FIG. 3D is a schematic diagram illustrating an earphone device worn on the right ear according to the first embodiment of the disclosure.

FIG. 4A is a schematic diagram of the scanning ranges according to the first embodiment of the disclosure.

FIG. 4B is a schematic diagram illustrating an earphone device being worn according to the first embodiment of the disclosure.

FIG. 5 is a flowchart of an identifying method of an earphone device according to an embodiment of the disclosure.

FIG. 6A is a schematic diagram illustrating the definition of the upper and lower limit distances configured corresponding to the left ear according to the first embodiment of the disclosure.

FIG. 6B is a schematic diagram illustrating the definition of the upper and lower limit distances configured corresponding to the right ear according to the first embodiment of the disclosure.

FIG. 7A is a schematic diagram of an earphone device according to the second embodiment of the disclosure.

FIG. 7B is a side diagram of the earphone device according to the second embodiment of the disclosure.

FIG. 8 is a schematic diagram illustrating the earphone device worn on the left ear and the right ear according to the second embodiment of the disclosure.

FIG. 9A is a schematic diagram of the scanning ranges according to the second embodiment of the disclosure.

FIG. 9B is a schematic diagram illustrating an earphone device being worn according to the second embodiment of the disclosure.

FIG. 10A is a schematic diagram of an earphone device according to the third embodiment of the disclosure.

FIG. 10B is a side diagram of the earphone device according to the third embodiment of the disclosure.

FIG. 11 is a schematic diagram illustrating earphone devices worn on the left ear and the right ear according to the third embodiment of the disclosure.

FIG. 12A is a schematic diagram of the scanning range according to the third embodiment of the disclosure.

FIG. 12B is a schematic diagram illustrating an earphone device being worn according to the third embodiment of the disclosure.

FIG. 13 is a schematic diagram of system interaction according to an embodiment of the disclosure.

### DETAILED DESCRIPTION OF DISCLOSED EMBODIMENTS

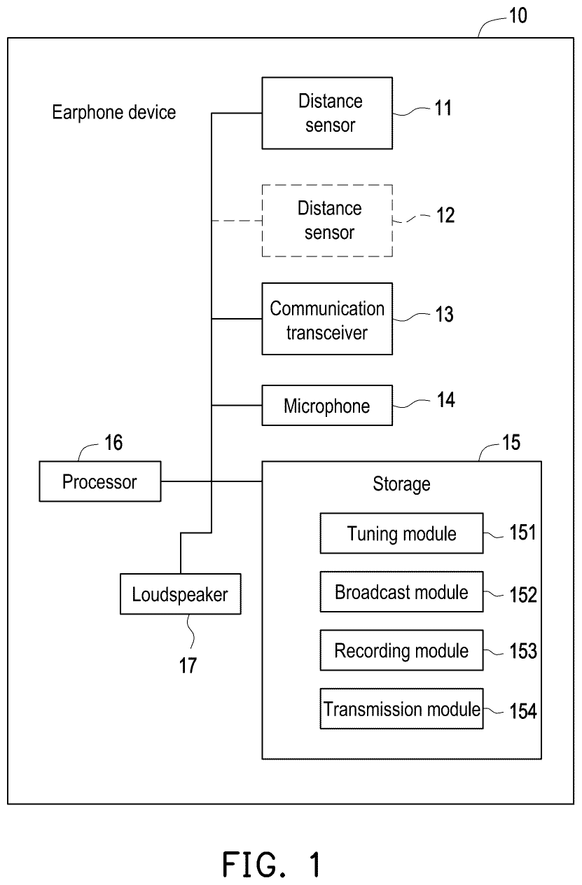

FIG. 1 is an element block diagram of an earphone device 10 according to an embodiment of the disclosure. Referring to FIG. 1, the earphone device 10 includes (but is not limited to) a distance sensor 11, a communication transceiver 13, a microphone 14, a storage 15, a processor 16, and a loudspeaker 17.

The distance sensor 11 may be an infrared transceiver set, a lidar, a radar, a ToF sensor, or a depth camera. In one embodiment, the distance sensor 11 is configured to detect foreign objects and their relative distances.

In an embodiment, the earphone device 10 may further include a distance sensor 12. For the implementation of the distance sensor 12, reference may refer to the description of the distance sensor 11, and are not repeated herein.

The communication transceiver 13 is, for example, a transceiver (which may include (but is not limited to) elements such as antennas, digital-to-analog/analog-to-digital converters, communication protocol processing chips, etc) that supports Wi-Fi or Bluetooth wireless networks. In one embodiment, the communication transceiver 13 is configured to transmit or receive data (e.g., audio data) via a wireless network.

The microphone 14 may be a type of microphone, such as dynamic, condenser, or electret condenser, etc., alternatively, the microphone 14 may also be a combination of other electronic elements, analog-to-digital converters, filters, and audio processors capable of receiving sound waves (e.g., human voice, ambient sound, machine operation sound, etc.) (i.e., sound reception or sound recording) and converting them into audio signals, alternatively, the microphone 14 is a digital microphone.

The storage 15 may be any type of fixed or movable random access memory (RAM), read only memory (ROM), flash memory, conventional hard disk drive (HDD), solid-state drive (SSD) or similar components. In one embodiment, the storage 15 is configured to store program codes, software modules (e.g., a tuning module 151, a broadcast module 152, a recording module 153 and a transmission module 154), configurations, data (e.g., range parameters, distance information, or left and right decision information), or files.

The processor 16 is coupled to the distance sensors 11 and 12, the communication transceiver 13, the microphone 14, and the storage 15. The processor 16 may be a central processing unit (CPU), a graphics processing unit (GPU), or other programmable general-purpose or special-purpose microprocessors, a digital signal processor (DSP), a programmable controller, a field programmable gate array (FPGA), an application-specific integrated circuit (ASIC), a system on a chip (SoC), or other similar elements, or a combination of elements thereof. In one embodiment, the processor 16 is configured to execute all or some of the operations of the earphone device 10, and may load and execute software modules, program codes, files, and/or data stored in the storage 15.

The loudspeaker 17 is coupled to the processor 16. The loudspeaker 17 may be a dynamic or balanced armature loudspeaker, a speaker, or an amplifier. In one embodiment, the loudspeaker 17 is configured to play audio.

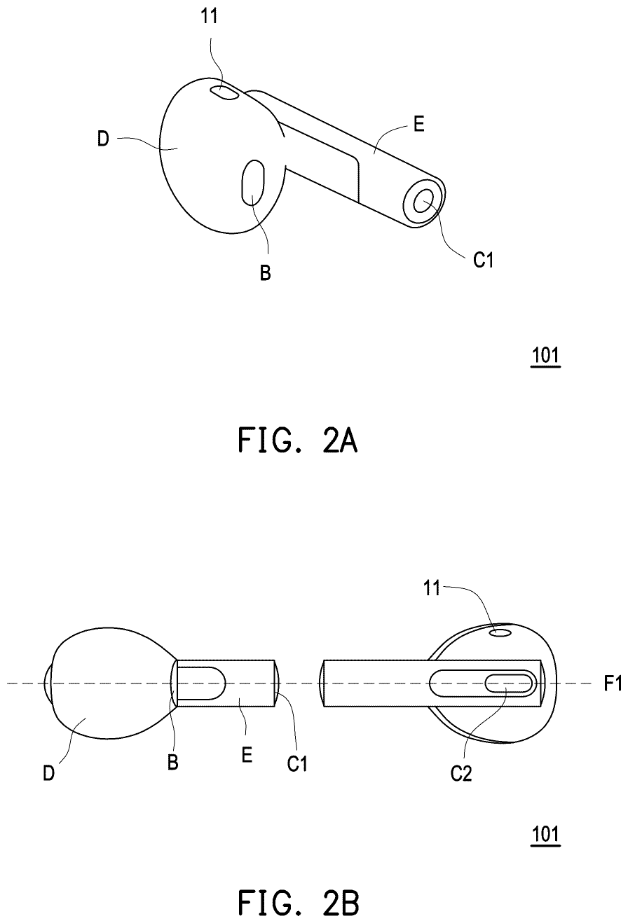

FIG. 2A is a schematic diagram of an earphone device 101 according to the first embodiment of the disclosure. Referring to FIG. 2A, the earphone device 101 includes an earphone body D and an extension rod E extending from the earphone body D. A single distance sensor 11 is disposed on the earphone body D, on the top side of the earphone body D from the perspective as shown in the figure. An outlet B of the loudspeaker 17 is disposed on one side of the earphone body D. On the other hand, a microphone C1 is disposed at an end of the extension rod E away from the earphone body D.

The earphone device 101 has a symmetrical design. FIG. 2B is a side diagram of the earphone device 101 according to the first embodiment of the disclosure. Referring to FIG. 2B, the geometric shapes of the earphone body D and the extension rod E are symmetrical to the central symmetry plane F1 (serving as the reference axis). In one embodiment, the microphone C1 is parallel to the outlet B of the loudspeaker 17 and faces the same direction, that is, towards the extension direction of the body of the extension rod E. A microphone C2 is disposed at another end of the extension rod E close to the earphone body D. In addition, the side diagram shown on the left side of FIG. 2B corresponds to the inner side of the earphone device 101, and the microphone C2 is disposed on the outer side of the earphone device 101. In one embodiment, the orientation of the body of the extension rod E and the outlet B of the loudspeaker 17 is parallel to the central symmetry plane F1 (e.g., parallel to the ground). In addition, when the user wears the earphone device 101, the extension direction of the body of the extension rod E and the orientation of the outlet B are substantially parallel to the line of sight of the eyes of the user.

However, the structural design of the earphone device 10 is not limited to the earphone device 101 shown in FIG. 2A and FIG. 2B, and any symmetrical earphone design is applicable.

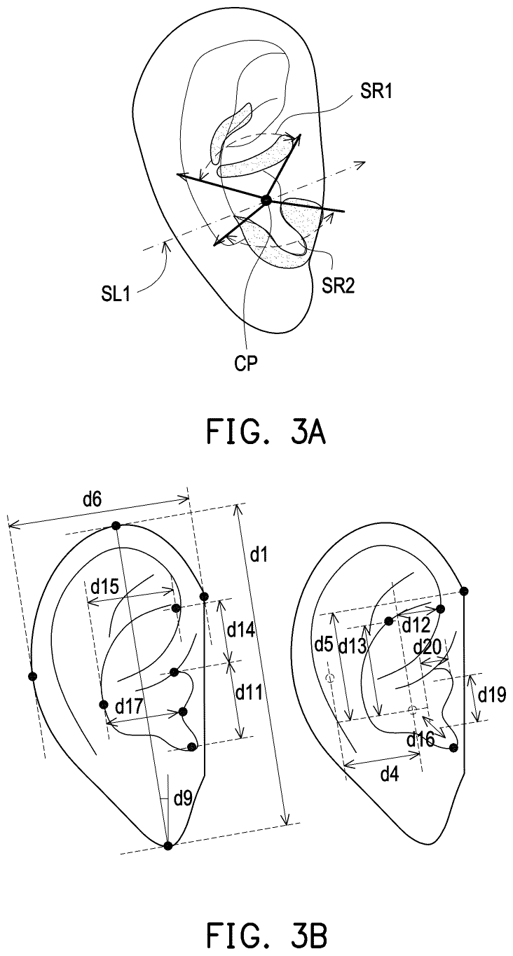

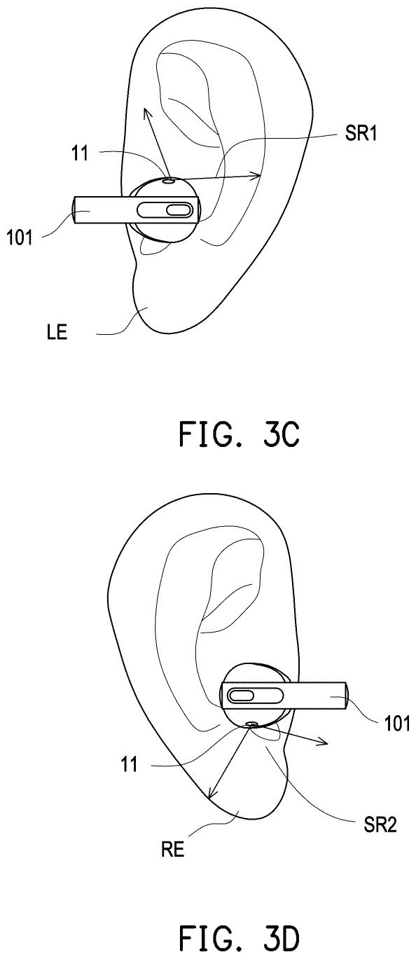

FIG. 3A is a schematic diagram of scanning ranges SR1 and SR2 according to an embodiment of the disclosure. Referring to FIG. 3A, the symmetry axis SL1 is, for example, parallel to, or is the central symmetry plane F1 shown in FIG. 2B. Referring to FIG. 2B, the symmetrically designed earphone device 101 may be worn on both left and right ears, so that when the user wears the earphone device 101, the wearing orientation may be determined through the sensing orientation of a single distance sensor 11 being upward or downward. Therefore, referring to FIG. 3A, the scanning range SR1 of the distance sensor 11 extends upward and outward from the concha center point CP and may correspond to the cymba concha (i.e., the sensing orientation is upward), or the scanning range SR2 of the distance sensor 11 extends downward and outward from the concha center point CP and may correspond to the cavum concha (i.e., the sensing orientation is downward).

It is worth noting that the outer ear structure of the ear is uneven. When the user wears the earphone device 101, the actual scanning ranges SR1 and SR2 may be limited by the contour of the outer ear.

FIG. 3B is a schematic diagram of distance and angle definitions according to an embodiment of the disclosure. Referring to FIG. 3B, the distance and angle between any two points within the outer contour may be used to define the structure of the outer contour. The cymba concha is the narrowest end of the outer ear. The cavum concha is a large, bowl-shaped hollow space in front of the ear canal. The tragus is a small pointed bulge located in front of the cavum concha. For example, the ear length d1, the center of concha to otobasion posterius length d4, the center of concha to otobasion superius length d5, the ear width d6, the ear angle d9, the cavum concha length d11, the center of concha to anterior cymba concha length d12, the center of concha to superius cymba concha length d13, the center of superius cymba concha to anterior cymba concha length d14, the posterior cymba concha to anterior cymba concha length d15, the center of concha to intertragic incisure length d16, the cavum concha width d17, the ear canal opening height d19, and the ear canal opening width d20 are shown in FIG. 3B. The scanning ranges SR1 and SR2 shown in FIG. 3A may be limited to the above distances.

FIG. 3C is a schematic diagram illustrating an earphone device 101 worn on the left ear LE according to the first embodiment of the disclosure. Referring to FIG. 3C, the scanning range SR1 of the distance sensor 11 extends upward and outward.

FIG. 3D is a schematic diagram illustrating an earphone device 101 worn on the right ear RE according to the first embodiment of the disclosure. Referring to FIG. 3C, the scanning range SR2 of the distance sensor 11 extends downward and outward.

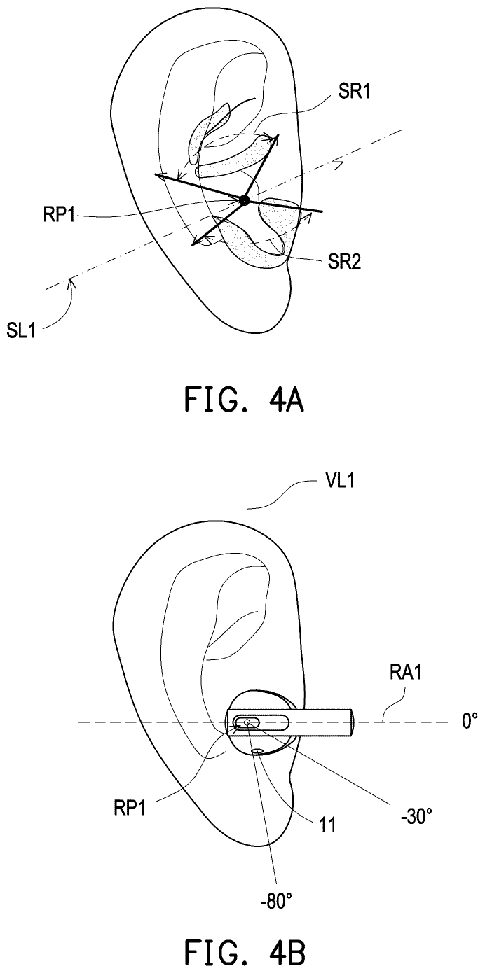

FIG. 4A is a schematic diagram of the scanning ranges SR1 and SR2 according to the first embodiment of the disclosure. Referring to FIG. 3C, FIG. 3D and FIG. 4A, the distance sensor 11 in FIG. 3C and FIG. 3D is close to (but not overlapping) the center of the concha (substantially located at the center of the earphone body of the earphone device 101). The position of the center of the concha may serve as the reference position RP1. The scanning range SR1 may be symmetrical to the scanning range SR2 relative to the symmetry axis SL1 (e.g., parallel to, or is the central symmetry plane F1 shown in FIG. 2B).

FIG. 4B is a schematic diagram illustrating an earphone device 101 being worn in an optimal state in the cavum concha according to the first embodiment of the disclosure. Referring to FIG. 4B, when the earphone body of the earphone device 101 is worn in the cavum concha, the reference axis RA1 (the central symmetry plane F1 as shown in FIG. 2B) may pass through the center (point) of concha (the reference position RP1 as shown in the figure) and be parallel to the horizontal plane (e.g.,) 0°. Thereby, the center (point) of the concha may be mapped to a virtual center point (reference position RP1 as shown in the figure) on the earphone body, and this reference position RP1 is located on the reference axis RA1. Referring to FIG. 2B and FIG. 4B. The extension rod E shown in FIG. 2B is parallel to the central symmetry plane F1. When the central symmetry plane F1 overlaps or is parallel to the reference axis RA1 shown in FIG. 4B, the body of the extension rod E is parallel to the reference axis RA1 passing through the reference position RP1.

Furthermore, a normal line passing through the reference position RP1 and perpendicular to the reference axis RA1 is referred to as a virtual normal line VL1. The line connecting the center point of the distance sensor 11 and the reference position RP1 has an included angle with respect to the reference axis RA1 passing through the reference position RP1, and the included angle is between −30 degrees and −80 degrees. The distance sensor 11 shown in FIG. 4B is configured at an included angle of about −70 degrees. However, the embodiment of the disclosure is not limited thereto. That is, the relative position of the distance sensor 11 may be configured within the above-mentioned included angle range (i.e., −30° to −80°).

In other embodiments, the extension rod E shown in FIG. 2B may intersect with the central symmetry plane F1, and the relative position of the distance sensor 11 is not limited by the above-mentioned included angle range.

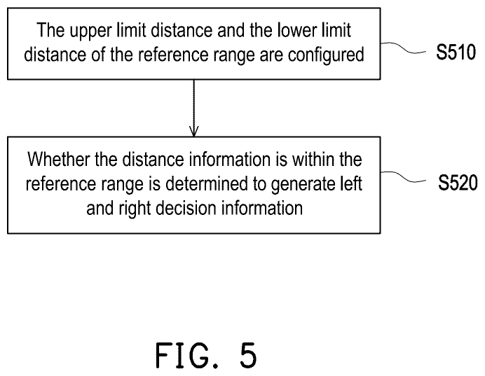

FIG. 5 is a flowchart of an identifying method of an earphone device according to an embodiment of the disclosure. Referring to FIG. 5, the processor 16 configures the upper limit distance and the lower limit distance of the reference range (step S510). Specifically, the reference range relates to the possible distance between the distance sensor 11 and the auricle. The upper limit distance and the lower limit distance are based on the distances between the reference position of the earphone device 10 and the contour of the cavum concha or cymba concha respectively. As described above in FIG. 3A, FIG. 3C, FIG. 3D and FIG. 4A, when the earphone device 101 is worn in the left ear LE as shown in FIG. 3C, the distance sensor 11 senses upward, so that the scanning range SR1 of the distance sensor 11 shown in FIG. 4A may correspond to the cymba concha. That is, the scanning range SR1 of the distance sensor 11 is limited by the contour of the cymba concha. Alternatively, when the earphone device 101 is worn in the right ear RE as shown in FIG. 3D, the distance sensor 11 senses downward, so that the scanning range SR2 of the distance sensor 11 shown in FIG. 4A may correspond to the cavum concha (i.e., the sensing orientation is downward). That is, the scanning range SR2 of the distance sensor 11 is limited by the contour of the cavum concha.

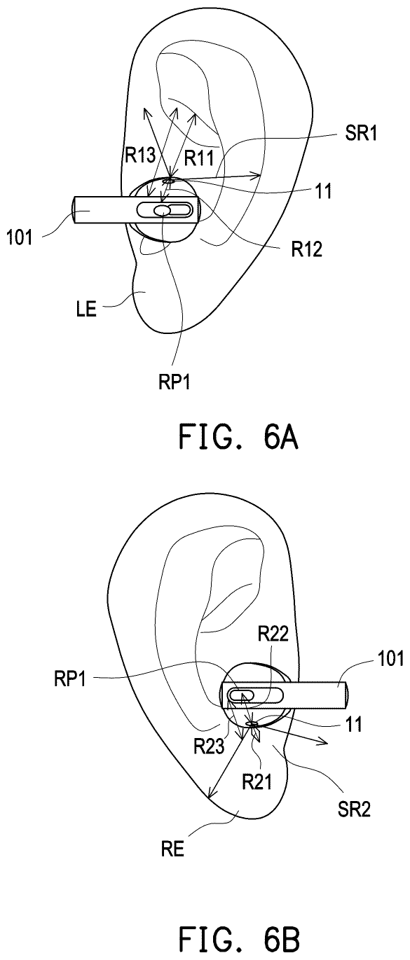

For example, FIG. 6A is a schematic diagram illustrating the definition of the upper and lower limit distances configured corresponding to the left ear LE according to the first embodiment of the disclosure. Referring to FIG. 6A, the sum of the distance R11 from the distance sensor 11 to the upper edge (i.e., the superius cymba concha) of the cymba concha and the distance R12 from the reference position RP1 to the distance sensor 11 is approximately the distance R13. Since the distance R12 is greater than zero, the upper limit of the distance R11 from the distance sensor 11 to the upper edge of the cymba concha is the distance R13. In terms of the distance definition in FIG. 3B, assuming that the reference position RP1 is located at the center of the concha, the distance R13 corresponds to or (approximately) equals to the center of concha to superius cymba concha length d13. On the other hand, when wearing the earphone body, the earphone body should be substantially inserted into the cavum concha. Therefore, based on the distance definition in FIG. 3B, assuming that the reference position RP1 is located at the center of the concha, the lower limit of the distance R12 from the reference position RP1 to the distance sensor 11 corresponds to or (approximately) equals to the cavum concha length d11. At this time, the processor 16 may configure the lower limit distance of the reference range as the length of the cavum concha (the cavum concha length d11 in FIG. 3B), configure the upper limit distance as the distance between the reference position RP1 and the upper edge of the cymba concha (the center of concha to superius cymba concha length d13 in FIG. 3B), and this reference range is used to determine that the left ear is worn as shown in FIG. 6A.

FIG. 6B is a schematic diagram illustrating the definition of the upper and lower limit distances configured corresponding to the right ear according to the first embodiment of the disclosure. Referring to FIG. 6B, the sum of the distance R21 from the reference position RP1 to the distance sensor 11 and the distance R22 from the distance sensor 11 to the lower edge of the cavum concha (i.e., the intertragic incisure) is approximately the distance R23. Since the distance R21 is greater than zero, the upper limit of the distance R22 from the distance sensor 11 to the lower edge of the cavum concha is the distance R23. In terms of the distance definition in FIG. 3B, assuming that the reference position RP1 is located at the center of the concha, the distance R23 corresponds to or (approximately) equals to the center of concha to intertragic incisure length d16. On the other hand, when wearing the earphone body, the earphone body should be substantially inserted into the cavum concha. Therefore, based on the distance definition in FIG. 3B, assuming that the reference position RP1 is located at the center of the concha, the lower limit of the distance R21 from the reference position RP1 to the distance sensor 11 corresponds to or (approximately) equals to zero. At this time, the processor 16 may configure the lower limit distance of the reference range to zero, configure the upper limit distance as the distance between the reference position RP1 and the intertragic incisure of the cavum concha (the center of concha to intertragic incisure length d16 in FIG. 3B), and this reference range is used to determine that the right ear is worn as shown in FIG. 6B.

In one embodiment, the reference range is defined according to the statistical distance between the center of the concha and the contour of the cavum concha or the cymba concha respectively. As described in FIG. 3B and FIG. 6A, when the left ear LE is worn, assuming that the reference position RP1 is located at the center of the concha, the reference range may be between the cavum concha length d11 (corresponding to the lower limit distance) and the center of concha to superius cymba concha length d13 (corresponding to the upper limit distance). Alternatively, as described in FIG. 3B and FIG. 6B, when the right ear RE is worn, assuming that the reference position RP1 is located at the center of the concha, the reference range may be between zero (corresponding to the lower limit distance) and the center of concha to intertragic incisure length d16 (corresponding to the upper limit distance). The above-mentioned cavum concha length d11, the center of concha to superius cymba concha length d13, and the center of concha to intertragic incisure length d16 are statistical values of multiple samples. For example, the samples were three-dimensional ear images of 230 Asians and 96 Europeans. For these three-dimensional ear images, the cavum concha length d11, the center of concha to superius cymba concha length d13, and the center of concha to intertragic incisure length d16 were measured respectively, and the statistical values (e.g., the largest value or the second largest value) of the cavum concha length d11, the center of concha to superius cymba concha length d13, and the center of concha to intertragic incisure length d16 in these three-dimensional ear images were calculated respectively.

It should be noted that the measured lengths in the samples may vary depending on race, age, or gender. In some application scenarios, limitations may be made to the race, age, and/or gender of the samples.

Referring to FIG. 5, the processor 16 determines whether the distance information is within the reference range to generate left and right decision information (step S520). Specifically, the distance sensor 11 or 12 (if present) may detect an object (e.g., an auricle) and obtain distance information (e.g., a value of the distance between the distance sensor 11 or 12 and the object). In one embodiment, the processor 16 may determine the distance information according to the statistical values of multiple sensing values of the distance sensor 11 or 12 within the scanning range. As shown in FIG. 4A, within the scanning range SR1 or SR2, the distance sensor 11 may respectively obtain sensing values corresponding to multiple angles, and the processor 16 may use statistical values (e.g., average or median) of these sensing values as distance information.

On the other hand, as explained above, the geometric shape of the outer ear and the configuration design of the distance sensor 11 or 12 (if present, which will be described in subsequent embodiments) have limitations. When the user wears the earphone device 10, the distance that the distance sensor 11 or 12 may sense has an upper limit and a lower limit (corresponding to the upper limit distance and the lower limit distance of the reference range respectively determined in step S510).

In addition, the left and right decision information is right ear is worn (as shown in FIG. 6B) or left ear worn (as shown in FIG. 6A). The description of step S510 has introduced that the reference range used to determine whether the right ear is worn and the reference range used to determine whether the left ear is worn are different (i.e., a difference exists). Therefore, the left and right decision information may be determined based on this difference.

In the first embodiment, referring to FIG. 3B and FIG. 6A, when the distance information is within the reference range where the lower limit distance is the cavum concha length d11 and the upper limit distance is the center of concha to superius cymba concha length d13 (i.e., d11<distance information<d13), the processor 16 determines that the left and right decision information indicates that left ear is worn.

Next, referring to FIG. 3B and FIG. 6B, when the distance information is within the reference range where the lower limit distance is zero and the upper limit distance is the center of concha to intertragic incisure length d16 (i.e., 0<distance information<d16), the processor 16 determines that the left and right decision information indicates that the right ear is worn.

In addition, referring to FIG. 3B, before determining the left and right decision information (e.g., when the user has just worn the earphone device 10 or 101), the processor 16 may determine whether the current distance information detected by the distance sensor 11 is less than a third lower limit value. This third lower limit value is the upper limit distance of the above-mentioned reference range, and is the distance (e.g., the center of concha to intertragic incisure length d16) between the reference position and the intertragic incisure of the cavum concha or the distance (e.g., the center of concha to superius cymba concha length d13) between the reference position and the upper edge of the cymba concha. Specifically, when the distance information is less than the third lower limit (e.g., the center of concha to superius cymba concha length d13 or the center of concha to intertragic incisure length d16), the processor 16 may then determine the subsequent left and right decision information (i.e., determine whether the subsequent distance information is within the reference range). Simply put, if the distance information is <d13 or the distance information is <d16, the processor 16 determines that the earphone body should have been placed in the cavum concha, so the processor 16 executes the steps shown in FIG. 5 to determine the left and right decision information. When the distance information is not less than the third lower limit value, the processor 16 prohibits/does not perform subsequent determination of left and right decision information. At this time, the earphone body has not yet been placed in the cavum concha, so it is unnecessary to determine to determine the left and right decision information.

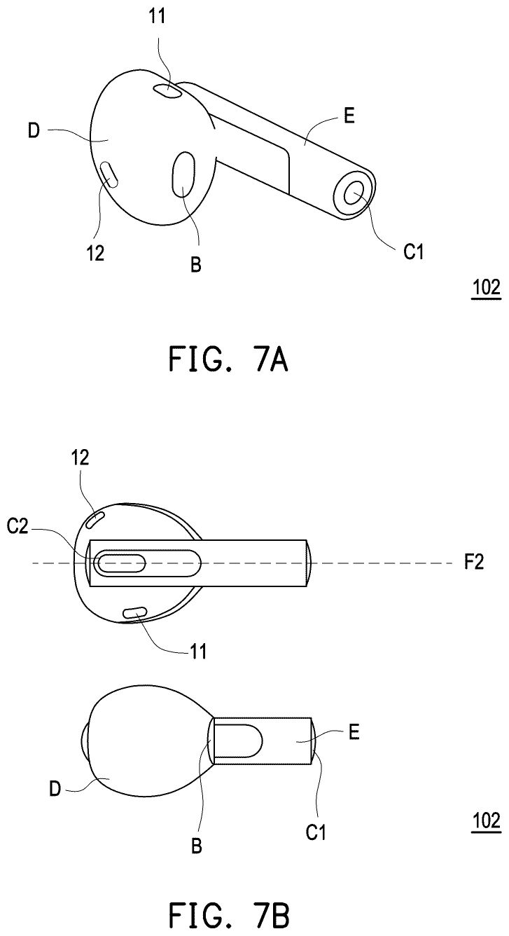

FIG. 7A is a schematic diagram of an earphone device 102 according to the second embodiment of the disclosure. Referring to FIG. 7A, compared with the earphone device 101 of the first embodiment shown in FIG. 2A, the earphone device 102 further includes a distance sensor 12. That is, the earphone device 102 has two distance sensors. A distance sensor 12 is disposed on the earphone body D, on a side of the earphone body D from the perspective as shown in the figure.

FIG. 7B is a side diagram of the earphone device 102 according to the second embodiment of the disclosure. Referring to FIG. 7B, the geometric shapes of the earphone body D and the extension rod E are symmetrical to the central symmetry plane F2 (serving as the reference axis). In one embodiment, the microphone C1 is parallel to the outlet B of the loudspeaker 17 and faces the same direction, that is, the extension direction of the body of the extension rod. A microphone C2 is disposed at another end of the extension rod E away from the earphone body D. In addition, the side diagram shown on the lower part of FIG. 7B corresponds to the inner side of the earphone device 102, and the microphone C2 is disposed on the outer side of the earphone device 102. In one embodiment, the orientation of the body of the extension rod E and the outlet B of the loudspeaker 17 is parallel to the central symmetry plane F2 (e.g., parallel to the ground). In addition, when the user wears the earphone device 102, the extension direction of the body of the extension rod E and the orientation of the outlet B are substantially parallel to the line of sight of the eyes of the user.

However, the structural design of the earphone device 10 is not limited to the earphone device 102 shown in FIG. 7A and FIG. 7B, and any symmetrical earphone design is applicable.

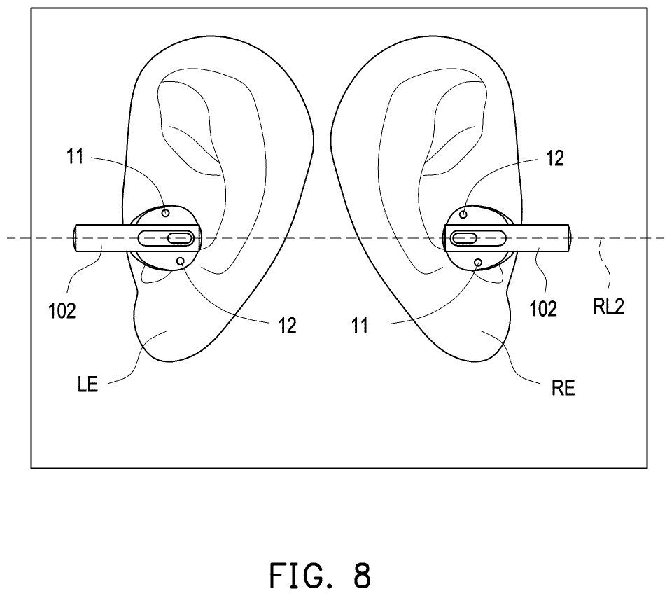

FIG. 8 is a schematic diagram illustrating the earphone device 102 worn on the left ear LE and the right ear RE according to the second embodiment of the disclosure. Referring to FIG. 8, the earphone device 102 of the second embodiment is respectively disposed on both sides relative to the reference axis RL2 (the central symmetry plane F2 as shown in FIG. 7B) through two distance sensors 11 and 12. When the earphone device 102 is worn on the left ear LE, the distance sensor 11 is located on the upper side of the earphone device 102, and the distance sensor 12 is located on the lower side of the earphone device 102. When the earphone device 102 is worn on the right ear RE, the distance sensor 11 is located on the lower side of the earphone device 102, and the distance sensor 12 is located on the upper side of the earphone device 102.

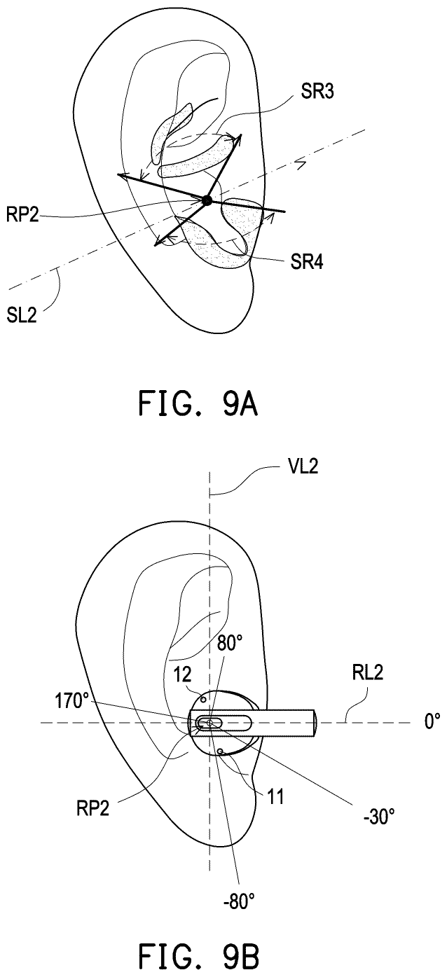

FIG. 9A is a schematic diagram of the scanning ranges SR3 and SR4 according to the second embodiment of the disclosure. Referring to FIG. 7A, FIG. 7B and FIG. 9A, the distance sensors 11 and 12 of FIG. 7A and FIG. 7B are close to (but not overlapping) the center of the concha (substantially located at the center of the earphone body of the earphone device 102). The position of the center of the concha may serve as the reference position RP2. The scanning range SR3 of the distance sensor 11 or 12 may be symmetrical to the scanning range SR4 relative to the symmetry axis SL2 (e.g., parallel to, or is the central symmetry plane F2 shown in FIG. 7B).

FIG. 9B is a schematic diagram illustrating an earphone device 102 being worn in an optimal state in the cavum concha according to the second embodiment of the disclosure. Referring to FIG. 9B, when the earphone body of the earphone device 102 is worn in the cavum concha, the reference axis RL2 (the central symmetry plane F1 as shown in FIG. 7B) may pass through the center (point) of concha (the reference position RP2 as shown in the figure) and be parallel to the horizontal plane (e.g., 0°). Thereby, the center (point) of the concha may be mapped to a virtual center point (reference position RP2 as shown in the figure) on the earphone body, and this reference position RP2 is located on the reference axis RL2. Referring to FIG. 7B and FIG. 9B, the extension rod E shown in FIG. 7B is parallel to the central symmetry plane F2. When the central symmetry plane F2 overlaps or is parallel to the reference axis RL2 shown in FIG. 9B, the body of the extension rod E is parallel to the reference axis RL2 passing through the reference position RP2.

Furthermore, a normal line passing through the reference position RP2 and perpendicular to the reference axis RL2 is referred to as a virtual normal line VL2. The line connecting the center point of the distance sensor 11 and the reference position RP2 has an included angle with respect to the reference axis RL2 passing through the reference position RP2, and the included angle is between −30 degrees and −80 degrees. The distance sensor 11 shown in FIG. 9B is configured at an included angle of about −70 degrees. However, the embodiment of the disclosure is not limited thereto. That is, the relative position of the distance sensor 11 may be configured within the above-mentioned included angle range (i.e., −30° to)−80°. On the other hand, the line connecting the center point of the distance sensor 12 and the reference position RP2 has a second included angle with respect to the reference axis RL2 passing through the reference position RP2, and the second included angle is between 80 degrees and 170 degrees. The distance sensor 12 shown in FIG. 9B is configured at a second included angle of about 105 degrees. However, the embodiment of the disclosure is not limited thereto. That is, the relative position of the distance sensor 12 may be configured within the above-mentioned included angle range (i.e., 80° to 170°).

In other embodiments, the extension rod E shown in FIG. 7B may intersect with the central symmetry plane F2, and the relative positions of the distance sensors 11 and 12 are not limited by the above-mentioned included angle range.

Regarding the determination of left and right decision information, the technical solution in step S520 is also applicable to the earphone device 102.

In the second embodiment, the distance sensor 12 is configured to obtain the second distance information. For the description of the second distance information, reference may be made to the aforementioned introduction to the distance information, which is not repeated herein. In addition, the processor 16 may configure a second upper limit distance and a second lower limit distance corresponding to the second reference range of the distance sensor 12. As introduced in step S510, the second upper limit distance and the second lower limit distance are based on the distances between the reference position RP of the earphone device 102 and the contour of the cavum concha or cymba concha respectively.

In the second embodiment, the determination of right ear is worn will be made through the reference range and the second reference range. Specifically, the processor 16 may configure the lower limit distance corresponding to the reference range of the distance sensor 11 to zero, configure the second lower limit distance corresponding to the second reference range of the distance sensor 12 as the length (the cavum concha length d11 in FIG. 3B) of the cavum concha, configure the upper limit distance of the reference range as the distance (the center of concha to intertragic incisure length d16 in FIG. 3B) between the reference position RP2 and the intertragic incisure of the cavum concha, and configure the second upper limit distance of the second reference range as the distance (the center of concha to superius cymba concha length d13 in FIG. 3B) between the reference position RP2 and the upper edge of the cymba concha.

That is, the processor 16 determines whether the second distance information is within the second reference range to generate the second left and right decision information in a different orientation from the distance sensor 11 to improve the accuracy of determining whether the right ear is worn or the left ear is worn. Therefore, in the second embodiment, the processor 16 jointly determines whether the earphone device 102 is worn on the right ear or on the left ear based on the left and right decision information and the second left and right decision information. Referring to FIG. 8, FIG. 6A and FIG. 6B, since the distance sensors 11 and 12 are located on both sides of the central symmetry plane F2, for the determination indicating that the right ear is worn corresponding to the distance sensor 11, reference may be made to FIG. 6B (e.g., determining whether the distance information is between zero and the center of concha to intertragic incisure length d16 in FIG. 3B, i.e., 0<distance information<d16), and for the determination indicating that the right ear worn corresponding to the distance sensor 12, reference may be made to FIG. 6A (e.g., determining whether the second distance information is between the cavum concha length d11 and the center of concha to superius cymba concha length d13 in FIG. 3B, i.e., d11<second distance information<d13).

Similarly, for the reference range and the second reference range configured to determine that the left ear is worn in the second embodiment, the processor 16 may configure the second lower limit distance corresponding to the second reference range of the distance sensor 12 to zero, configure the lower limit distance corresponding to the reference range of the distance sensor 11 as the length (the cavum concha length d11 in FIG. 3B) of the cavum concha, configure the second upper limit distance of the second reference range as the distance (the center of concha to intertragic incisure length d16 in FIG. 3B) between the reference position RP2 and the intertragic incisure of the cavum concha, and configure the upper limit distance of the reference range as the distance (the center of concha to superius cymba concha length d13 in FIG. 3B) between the reference position RP2 and the upper edge of the cymba concha. Referring to FIG. 8, FIG. 6A and FIG. 6B, since the distance sensors 11 and 12 are located on both sides of the central symmetry plane F2, for the determination indicating that the left ear is worn corresponding to the distance sensor 11, reference may be made to FIG. 6A (e.g., determining whether the distance information is between the cavum concha length d11 and the center of concha to superius cymba concha length d13 in FIG. 3B, i.e., d11<distance information<d13), and for the determination indicating that the left ear worn corresponding to the distance sensor 12, reference may be made to FIG. 6B (e.g., determining whether the second distance information is between zero and the center of concha to intertragic incisure length d16 in FIG. 3B, i.e., 0<second distance information<d16).

In the second embodiment, since the distance sensors 11 and 12 respectively obtain two pieces of distance information, the processor 16 may select the one with the smallest value (i.e., the shortest distance) among the two pieces of distance information or cross-analyze the two pieces of distance information to plan a standard deviation, and determine whether the selected distance information is within the reference range. In this way, the reliability and accuracy of data determination may be improved.

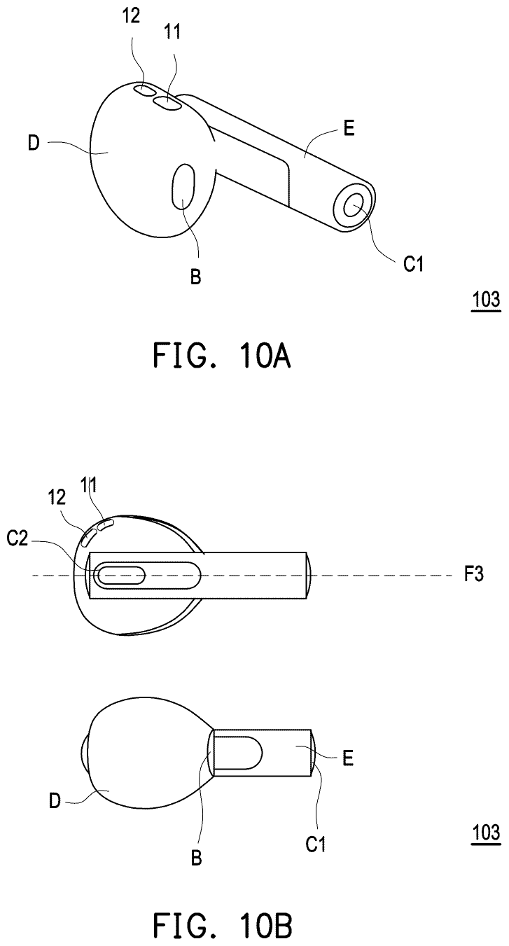

FIG. 10A is a schematic diagram of an earphone device 103 according to the third embodiment of the disclosure. Referring to FIG. 10A, compared with the earphone device 101 of the first embodiment shown in FIG. 2A, the earphone device 103 further includes a distance sensor 12. That is, the earphone device 102 has two distance sensors. A distance sensor 12 is disposed on the earphone body D, on a side of the earphone body D from the perspective as shown in the figure.

FIG. 10B is a side diagram of the earphone device 103 according to the third embodiment of the disclosure. Referring to FIG. 10B, the geometric shapes of the earphone body D and the extension rod E are symmetrical to the central symmetry plane F3 (serving as the reference axis). In one embodiment, the microphone C1 is parallel to the outlet B of the loudspeaker 17. A microphone C2 is disposed at another end of the extension rod E. In addition, the side diagram shown on the lower part of FIG. 10B corresponds to the inner side of the earphone device 103, and the microphone C2 is disposed on the outer side of the earphone device 103. In one embodiment, the orientation of the body of the extension rod E and the outlet B of the loudspeaker 17 is parallel to the central symmetry plane F3 (e.g., parallel to the ground). In addition, when the user wears the earphone device 103, the extension direction of the body of the extension rod E and the orientation of the outlet B are substantially parallel to the line of sight of the eyes of the user.

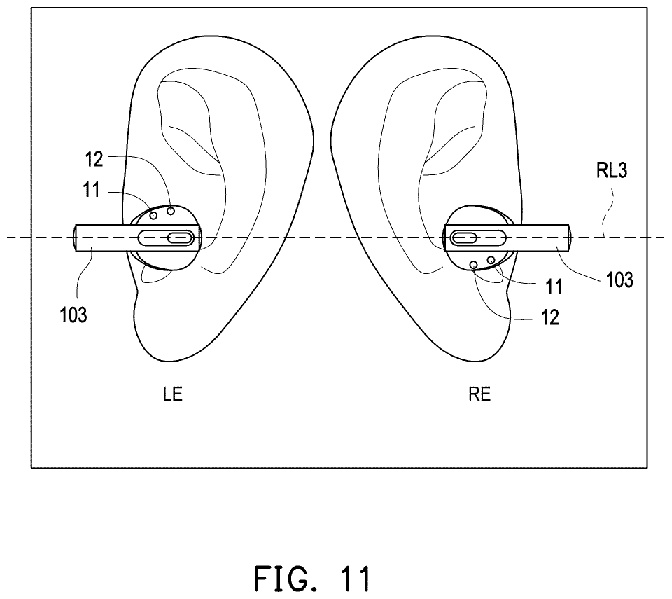

However, the structural design of the earphone device 10 is not limited to the earphone device 102 shown in FIG. 10A and FIG. 10B, and any symmetrical earphone design is applicable. FIG. 11 is a schematic diagram illustrating the earphone device 103 worn on the left ear

LE and the right ear RE according to the third embodiment of the disclosure. Referring to FIG. 11. like the earphone device of the second embodiment, the third embodiment also uses two distance sensors 11 and 12, but both distance sensors are disposed on the same side relative to the reference axis RL3 (the central symmetry plane F3 in FIG. 10B). The distance sensor 11 and the distance sensor 12 are adjacent to each other but do not overlap. When the earphone device 103 is worn on the left ear LE, the distance sensors 11 and 12 are both located on the upper side of the earphone device 103. When the earphone device 103 is worn on the right ear RE, the distance sensors 11 and 12 are both located on the lower side of the earphone device 103.

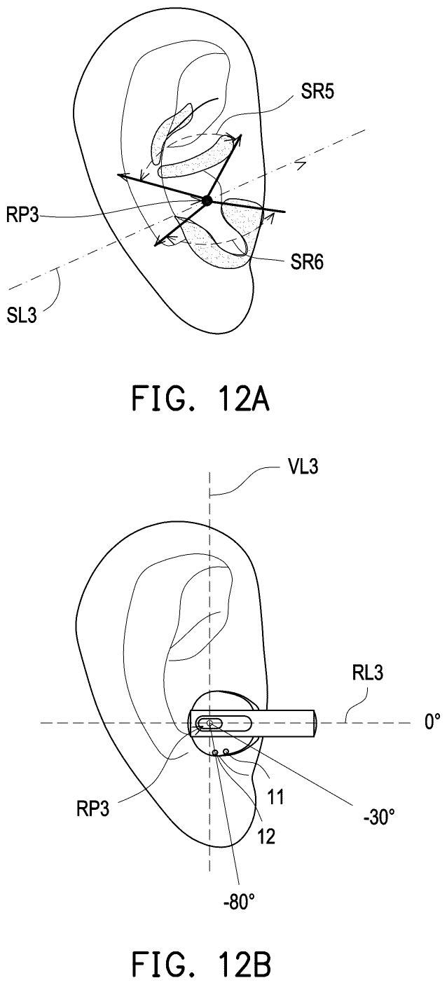

FIG. 12A is a schematic diagram of the scanning range according to the third embodiment of the disclosure. Referring to FIG. 10A, FIG. 10B and FIG. 12A, the distance sensors 11 and 12 of FIG. 10A and FIG. 10B are close to (but not overlapping) the center of the concha (substantially located at the center of the earphone body of the earphone device 103). The position of the center of the concha may serve as the reference position RP3. The scanning range SR5 of the distance sensor 11 or 12 may be symmetrical to the scanning range SR6 relative to the symmetry axis SL3 (e.g., parallel to, or is the central symmetry plane F3 shown in FIG. 10B).

FIG. 12B is a schematic diagram illustrating an earphone device 103 being worn in an optimal state in the cavum concha according to the third embodiment of the disclosure. Referring to FIG. 12B, when the earphone body of the earphone device 103 is worn in the cavum concha, the reference axis RL3 (the central symmetry plane F3 as shown in FIG. 10B) may pass through the center (point) of concha (the reference position RP3 as shown in the figure) and be parallel to the horizontal plane (e.g., 0°). Thereby, the center (point) of the ear concha may be mapped to a virtual center point (reference position RP3 as shown in the figure) on the earphone body, and this reference position RP3 is located on the reference axis RL3. Referring to FIG. 10B and FIG. 12B, the extension rod E shown in FIG. 10B is parallel to the central symmetry plane F3. When the central symmetry plane F3 overlaps or is parallel to the reference axis RL3 shown in FIG. 12B, the body of the extension rod E is parallel to the reference axis RL3 passing through the reference position RP3.

Furthermore, a normal line passing through the reference position RP3 and perpendicular to the reference axis RL3 is referred to as a virtual normal line VL3. The line connecting the center point of the distance sensors 11 and 12 and the reference position RP3 has an included angle with respect to the reference axis RL3 passing through the reference position RP3, and the included angle is between −30 degrees and −80 degrees. The distance sensor 11 shown in FIG. 12B is configured at an included angle of about −60 degrees, and the distance sensor 12 is configured at a second included angle of about 80 degrees. However, the embodiment of the disclosure are not limited thereto. That is, the relative positions of the distance sensors 11 and 12 may be configured within the above-mentioned included angle range.

In other embodiments, the extension rod E shown in FIG. 10B may intersect with the central symmetry plane F3, and the relative positions of the distance sensors 11 and 12 are not limited by the above-mentioned included angle range.

Regarding the determination of left and right decision information, the technical solution in step S520 is also applicable to the earphone device 103.

In the third embodiment, the determination of whether the right ear is worn is made through the following reference range and the second reference range. The processor 16 may configure the lower limit distance corresponding to the reference range of the distance sensor 11 and the second lower limit distance corresponding to the second reference range of the distance sensor 12 to zero, and configure the upper limit distance of the reference range and the second upper limit distance of the second reference range as the distance (the center of concha to intertragic incisure length d16 in FIG. 3B) between the reference position RP3 and the intertragic incisure of the cavum concha.

Different from the second embodiment, although the processor 16 also additionally determines whether the second distance information is within the second reference range, the second left and right decision information is generated in the same orientation as the distance sensor 11 to improve the accuracy of determining whether the right ear is worn or the left ear is worn. Therefore, in the third embodiment, the processor 16 may jointly determine whether the earphone device 103 is worn on the right ear or on the left ear based on the left and right decision information and the second left and right decision information. Referring to FIG. 8, FIG. 6A and FIG. 6B, since the distance sensors 11 and 12 are located on the same side of the central symmetry plane F3, for the determination indicating that the right ear is worn corresponding to the distance sensors 11 and 12, reference may be made to FIG. 6B (e.g., determining whether the distance information and/or the second distance information is between zero and the center of concha to intertragic incisure length d16 in FIG. 3B, i.e., 0<distance information and/or the second distance information<d16).

For the reference range and the second reference range configured to determine that the left ear is worn in the third embodiment, the processor 16 may configure the lower limit distance corresponding to the reference range of the distance sensor 11 and the second lower limit distance corresponding to the second reference range of the distance sensor 12 to the length (the cavum concha length d11 in FIG. 3B) of the cavum concha, and configure the upper limit distance of the reference range and the second upper limit distance of the second reference range as the distance (the center of concha to superius cymba concha length d13 in FIG. 3B) between the reference position RP3 and the upper edge of the cymba concha. The above reference range and the second reference range are used to determine whether the left ear is worn. Referring to FIG. 6A and FIG. 6B, since the distance sensors 11 and 12 are located on the same side of the central symmetry plane F3, for the determination indicating that the left ear is worn corresponding to the distance sensors 11 and 12, reference may be made to FIG. 6A (e.g., determining whether the distance information and/or the second distance information is between the cavum concha length d11 and the center of concha to superius cymba concha length d13 in FIG. 3B, i.e., d11<distance information and/or the second distance information<d13).

Like the second embodiment, the distance sensors 11 and 12 of the third embodiment also respectively obtain two pieces of distance information, the processor 16 may select the one with the smallest value (i.e., the shortest distance) among the two pieces of distance information or cross-analyze the two pieces of distance information to plan a standard deviation, and determine whether the selected distance information is within the reference range. In this way, the reliability and accuracy of data determination may be improved.

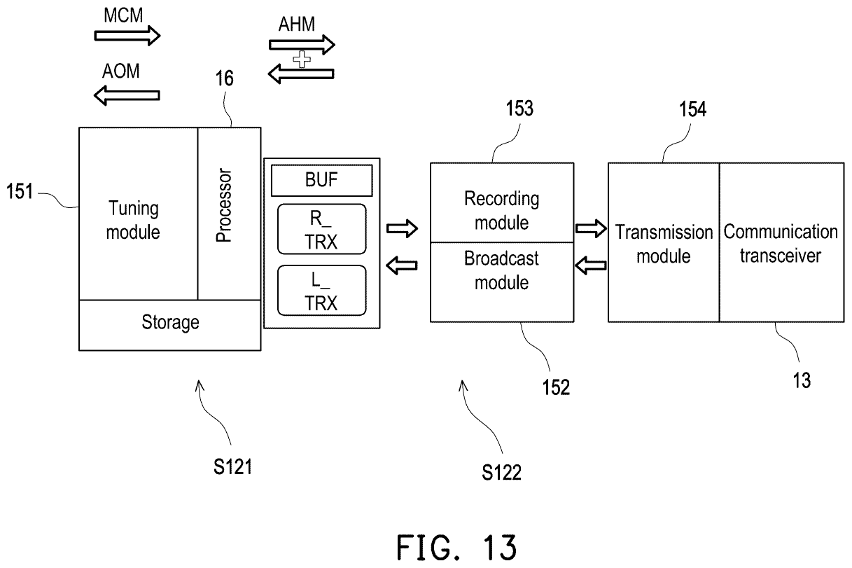

FIG. 13 is a schematic diagram of system interaction according to an embodiment of the disclosure. Referring to FIG. 13, the processor 16 may execute the tuning module 151, the broadcast module 152, the recording module 153 and the transmission module 154 respectively to provide corresponding application modes. In the local mode, the processor 16 provides three modes: music listening mode MCM (implemented by executing the broadcast module 152), recording mode AOM (implemented by executing the recording module 153), and hearing aid mode AHM (implemented by the tuning module 151). In the external communication mode, the processor 16 provides a transmission mode (implemented by executing the transmission module 154).

In the music listening mode MCM and/or the recording mode AOM, the processor 16 may achieve left and right channel switching for the broadcast module 152 and/or the recording module 153 by switching the left channel transmission and reception audio data L_TRX and the right channel transmission and reception audio data R_TRX through the buffer BUF.

In the hearing aid mode AHM, the processor 16 may select one of the left channel mode and the right channel mode according to the left and right decision information. The left channel mode and the right channel mode have corresponding a hearing compensation coefficient. The storage 15 stores the hearing compensation coefficients corresponding to the left channel mode and the right channel mode. When the left and right decision information is right ear is worn, the tuning module 151 loads the hearing compensation coefficient corresponding to the right channel mode from the storage 15 and compensates the right channel transmission and reception audio data R_TRX (step S121), and the broadcast module 152 plays the compensated right channel transmission and reception audio data R_TRX (step S122) to compensate for the hearing distortion of the right ear through the hearing compensation coefficient of the right channel mode. When the left and right decision information is left ear is worn, the tuning module 151 loads the hearing compensation coefficient corresponding to the left channel mode from the storage 15 and compensates the left channel transmission and reception audio data L_TRX (step S121), and the broadcast module 152 plays the compensated left channel transmission and reception audio data L_TRX (step S122) to compensate for the hearing distortion of the left ear through the hearing compensation coefficient of the left channel mode.

In one embodiment, the tuning module 151 may provide functions such as mode switching, compensation fine-tuning, etc., and may be automatically controlled by the system. Alternatively, the display connected to an external device via the communication transceiver 13 (e.g., Wi-Fi or Bluetooth) provides a user interface for mode switching and compensation fine-tuning, allowing the user to operate on this user interface to adjust to the customized settings suitable for the current situation.

To sum up, in the earphone device and the identifying method of wearing according to the embodiment of the disclosure, based on the geometric difference between the cavum concha and the cymba concha, geometric scanning of these two places is performed through a distance sensor to realize the identification function of left and right ear wearing. In this way, the user may directly put on the earphone device without having to identify the wearing position of the earphone device, thus improving the user experience. In addition, left and right channel switching and adjustment may be triggered instantly to ensure that users obtain the optimal listening experience.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. An earphone device, comprising:
a distance sensor, configured to obtain distance information;
a storage, configured to store program code; and
a processor, coupled to the distance sensor and the storage, and configured to load the program code and executing:
configuring an upper limit distance and a lower limit distance of a reference range, wherein the upper limit distance and the lower limit distance are based on distances between a reference position of the earphone device and a contour of a cavum concha or a cymba concha respectively; and
determining whether the distance information is within the reference range to generate left and right decision information, wherein the left and right decision information is whether a right ear is worn or a left ear is worn.

2. The earphone device according to claim 1, wherein the processor is further configured to execute:
configuring the lower limit distance to zero, and configuring the upper limit distance as a distance between the reference position and an intertragic incisure of the cavum concha, wherein the reference range is configured to determine whether the right ear is worn.

3. The earphone device according to claim 1, wherein the processor is further configured to execute:
configuring the lower limit distance as a length of the cavum concha, and configuring the upper limit distance as a distance between the reference position and an upper edge of the cymba concha, wherein the reference range is configured to determine whether the left ear is worn.

4. The earphone device according to claim 1, further comprising:
a second distance sensor, coupled to the processor and configured to obtain second distance information, wherein the processor is further configured to execute:
configuring a second upper limit distance and a second lower limit distance of a second reference range, wherein the second upper limit distance and the second lower limit distance are based on a distance between the reference position of the earphone device and the contour of the cavum concha or the cymba concha respectively;
determining whether the second distance information is within the second reference range to generate a second left and right decision information, wherein the second left and right decision information is whether the right ear is worn or the left ear is worn; and
determining whether the earphone device is the right ear is worn or the left ear is worn based on the left and right decision information and the second left and right decision information.

5. The earphone device according to claim 4, wherein the distance sensor and the second distance sensor are disposed on a same side of the reference position, and the processor is further configured to execute:
configuring the lower limit distance and the second lower limit distance to zero, and configuring the upper limit distance and the second upper limit distance as a distance between the reference position and an intertragic incisure of the cavum concha, wherein the reference range and the second reference range are configured to determine whether the right ear is worn; or
configuring the lower limit distance and the second lower limit distance as a length of the cavum concha, and configuring the upper limit distance and the second upper limit distance as a distance between the reference position and an upper edge of the cymba concha, wherein the reference range and the second reference range are configured to determine whether the left ear is worn.

6. The earphone device according to claim 4, wherein the distance sensor and the second distance sensor are disposed on opposite sides of the reference position, and the processor is further configured to execute:
configuring the lower limit distance to zero, configuring the second lower limit distance as a length of the cavum concha, configuring the upper limit distance as a distance between the reference position and an intertragic incisure of the cavum concha, and configuring the second upper limit distance as a distance between the reference position and an upper edge of the cymba concha, wherein the reference range and the second reference range are configured to determine whether the right ear is worn; or
configuring the lower limit distance as the length of the cavum concha, configuring the second lower limit distance to zero, configuring the upper limit distance as the distance between the reference position and the upper edge of the cymba concha, and configuring the second upper limit distance as the distance between the reference position and the intertragic incisure of the cavum concha, wherein the reference range and the second reference range are configured to determine whether the left ear is worn.

7. The earphone device according to claim 1, wherein the processor is further configured to execute:
determining the distance information according to a statistical value of a plurality of sensing values within a scanning range of the distance sensor.

8. The earphone device according to claim 1, wherein the processor is further configured to execute:
determining whether the distance information is less than a third lower limit value, wherein the third lower limit value is the upper limit distance and is a distance between the reference position and an intertragic incisure of the cavum concha or a distance between the reference position and an upper edge of the cymba concha; and
determining whether the distance information is within the reference range when the distance information is less than the third lower limit value.

9. The earphone device according to claim 1, wherein a line connecting the distance sensor and the reference position has an included angle with respect to a reference axis passing through the reference position, and the included angle is between −30 degrees and −80 degrees.

10. The earphone device according to claim 1, further comprising:
a microphone;
an earphone body, wherein the distance sensor is disposed on the earphone body, and the reference position is located at a center of the earphone body; and
an extension rod, extending from the earphone body and parallel to a reference axis passing through the reference position, wherein the microphone is disposed on the extension rod.

11. The earphone device according to claim 9, wherein a line connecting the second distance sensor and the reference position has a second included angle with respect to the reference axis, and the second included angle is between −30 degrees and −80 degrees, and the distance sensor is adjacent to but does not overlap the second distance sensor.

12. The earphone device according to claim 9, wherein a line connecting the second distance sensor and the reference position has a second included angle with respect to the reference axis, and the second included angle is between 80 degrees and 170 degrees.

13. The earphone device according to claim 1, wherein the processor is further configured to execute:
selecting one of a left channel mode and a right channel mode according to the left and right decision information, wherein the left channel mode and the right channel mode have a corresponding hearing compensation coefficient.

14. An identifying method of wearing, suitable for an earphone device, wherein the earphone device comprises a distance sensor, and the identifying method comprises:
configuring an upper limit distance and a lower limit distance of a reference range, wherein the upper limit distance and the lower limit distance are based on distances between a reference position of the earphone device and a contour of a cavum concha or a cymba concha respectively; and
determining whether distance information obtained by the distance sensor is within the reference range to generate left and right decision information, wherein the left and right decision information is whether a right ear is worn or a left ear is worn.

15. The identifying method of wearing according to claim 14, wherein configuring the upper limit distance and the lower limit distance of the reference range comprises:
configuring the lower limit distance to zero, and configuring the upper limit distance as a distance between the reference position and an intertragic incisure of the cavum concha, wherein the reference range is configured to determine whether the right ear is worn.

16. The identifying method of wearing according to claim 14, wherein configuring the upper limit distance and the lower limit distance of the reference range comprises:
configuring the lower limit distance as a length of the cavum concha, and configuring the upper limit distance as a distance between the reference position and an upper edge of the cymba concha, wherein the reference range is configured to determine whether the left ear is worn.

17. The identifying method of wearing according to claim 14, wherein the earphone device further comprises a second distance sensor, and the identifying method further comprises:
configuring a second upper limit distance and a second lower limit distance of a second reference range, wherein the second upper limit distance and the second lower limit distance are based on distances between the reference position of the earphone device and the contour of the cavum concha or the cymba concha respectively;
determining whether second distance information obtained by the second distance information is within the second reference range to generate a second left and right decision information, wherein the second left and right decision information is whether the right ear is worn or the left ear is worn; and
determining whether the earphone device is the right ear is worn or the left ear is worn based on the left and right decision information and the second left and right decision information.

18. The identifying method of wearing according to claim 17, wherein the distance sensor and the second distance sensor are disposed on a same side of the reference position, and configuring the upper limit distance and the lower limit distance of the reference range comprises:
configuring the lower limit distance and the second lower limit distance to zero, and configuring the upper limit distance and the second upper limit distance as a distance between the reference position and an intertragic incisure of the cavum concha, wherein the reference range and the second reference range are configured to determine whether the right ear is worn; or
configuring the lower limit distance and the second lower limit distance as a length of the cavum concha, and configuring the upper limit distance and the second upper limit distance as a distance between the reference position and an upper edge of the cymba concha, wherein the reference range and the second reference range are configured to determine whether the left ear is worn.

19. The identifying method of wearing according to claim 17, wherein the distance sensor and the second distance sensor are disposed on opposite sides of the reference position, and configuring the upper limit distance and the lower limit distance of the reference range comprises:
configuring the lower limit distance to zero, configuring the second lower limit distance as a length of the cavum concha, configuring the upper limit distance as a distance between the reference position and an intertragic incisure of the cavum concha, and configuring the second upper limit distance as a distance between the reference position and an upper edge of the cymba concha, wherein the reference range and the second reference range are configured to determine whether the right ear is worn; or
configuring the lower limit distance as the length of the cavum concha, configuring the second lower limit distance to zero, configuring the upper limit distance as the distance between the reference position and the upper edge of the cymba concha, and configuring the second upper limit distance as the distance between the reference position and the intertragic incisure of the cavum concha, wherein the reference range and the second reference range are configured to determine whether the left ear is worn.

20. The identifying method of wearing according to claim 14, further comprising:
determining the distance information according to a statistical value of a plurality of sensing values within a scanning range of the distance sensor.

21. The identifying method of wearing according to claim 14, wherein determining whether the distance information obtained by the distance sensor is within the reference range comprises:
determining whether the distance information is less than a third lower limit value, wherein the third lower limit value is the upper limit distance and is a distance between the reference position and an intertragic incisure of the cavum concha or a distance between the reference position and an upper edge of the cymba concha; and
determining whether the distance information is within the reference range when the distance information is less than the third lower limit value.

22. The identifying method of wearing according to claim 14, further comprising:
selecting one of a left channel mode and a right channel mode according to the left and right decision information, wherein the left channel mode and the right channel mode have a corresponding hearing compensation coefficient.
